(19) United States
(12) Patent Application Publication
(10) Pub. No.: US 2020/0118782 A1
(43) Pub. Date: Apr. 16, 2020

(54) KLYSTRON

(71) Applicant: CANON ELECTRON TUBES & DEVICES CO., LTD., Otawara-shi (JP)

(72) Inventors: Toshiro ANNO, Otawara (JP); Yoshihisa OKUBO, Otawara (JP)

(73) Assignee: CANON ELECTRON TUBES & DEVICES CO., LTD., Otawara-shi (JP)

(21) Appl. No.: 16/713,123

(22) Filed: Dec. 13, 2019

Related U.S. Application Data
(63) Continuation of application No. PCT/JP2017/046311, filed on Dec. 25, 2017.

(30) Foreign Application Priority Data
Jun. 13, 2017 (JP) 2017-115927

(51) Int. Cl. H01J 25/10; H01J 23/20; H01J 23/027

(52) U.S. Cl. CPC H01J 25/10; H01J 23/027; H01J 23/20

(57) ABSTRACT

According to one embodiment, a klystron includes an electron gun unit, a plurality of resonant cavities, a collector, and a plurality of drift tubes. The resonant cavities include an input cavity, a plurality of intermediate cavities, and an output cavity, positioned sequentially along the traveling direction of electrons from the electron gun unit. The intermediate cavities include a plurality of second harmonic cavities. The collector captures the electrons that have passed through the resonant cavities. The drift tubes are provided between the electron gun unit and the input cavity, between the resonant cavities, and between the output cavity and the collector.

### CROSS-REFERENCE TO RELATED APPLICATIONS

This application is a Continuation Application of PCT Application No. PCT/JP2017/046311, filed Dec. 25, 2017 and based upon and claiming the benefit of priority from Japanese Patent Application No. 2017-115927, filed Jun. 13, 2017, the entire contents of all of which are incorporated herein by reference.

### FIELD

Embodiments described herein relate generally to a klystron.

### BACKGROUND

A klystron is an electron tube used to amplify high-frequency power, and comprises an electron gun unit that emits electrons, input and output units of high-frequency power, a high-frequency interaction unit, and a collector that captures used electrons. The high-frequency interaction unit is composed of a plurality of resonant cavities arranged in the traveling direction of electrons. The resonant cavities include an input cavity that inputs high-frequency power, an output cavity that outputs high-frequency power, and a plurality of intermediate cavities between the input cavity and the output cavity. The electron gun unit and the high-frequency interaction unit, the plurality of resonant cavities constituting the high-frequency interaction unit, and the high-frequency interaction unit and the collector unit are connected by drift tubes, respectively.

In the klystron having such a structure, the electrons emitted from the electron gun unit pass through the input cavity, and are bunched by interacting with a plurality of intermediate cavities ahead of the input cavity. The kinetic energy of the bunched electrons is applied to the high frequency input from the input cavity, and the bunched electrons in the output cavity are decelerated to be extracted as high-frequency power amplified to the target output from the output unit.

In addition, a klystron using a second harmonic cavity as one of a plurality of intermediate cavities to enhance the effect of bunching the electrons and to increase the efficiency has been developed.

However, a klystron has problems that the bunched electrons tend to spread in the traveling direction since they repel each other due to space charge, and that the electrons cannot be uniformly decelerated by the output cavity and the efficiency of conversion into high-frequency power can hardly be improved since the speed of the electrons is varied.

### BRIEF DESCRIPTION OF THE DRAWINGS

FIG. 1 is a cross-sectional view showing a structure of a klystron of a first embodiment.

FIG. 2 is a cross-sectional view showing a part of a tube container of the klystron shown in FIG. 1, and showing a second harmonic cavity and the like.

FIG. 3 is a cross-sectional view showing a part of the tube container of the klystron shown in FIG. 1, illustrating an interval of a resonant cavity.

FIG. 4 is a cross-sectional view showing the tube container and collector of the klystron of a second embodiment, illustrating a diameter of a drift tube.

FIG. 5 is a cross-sectional view showing a tube container and a collector of a klystron of a third embodiment, illustrating a cavity cell and the like.

FIG. 6 is a cross-sectional view showing a tube container and a collector of a klystron of a fourth embodiment, illustrating a cavity cell and the like.

### DETAILED DESCRIPTION

In general, according to one embodiment, there is provided a klystron comprising: an electron gun unit that emits electrons; a plurality of resonant cavities including an input cavity, a plurality of intermediate cavities, and an output cavity that are sequentially located along the traveling direction of electrons from the electron gun unit, the plurality of intermediate cavities including a plurality of second harmonic cavities; a collector that captures electrons passing through the plurality of resonant cavities; and a plurality of drift tubes provided between the electron gun unit and the input cavity, between the plurality of resonant cavities, and between the output cavity and the collector.

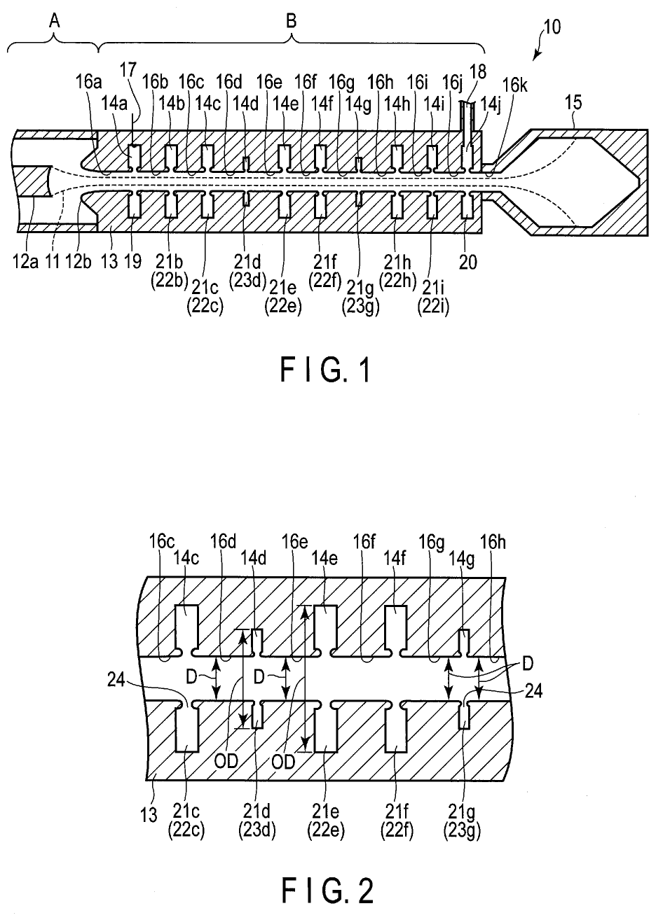

A first embodiment will be described hereinafter with reference to FIG. 1 to FIG. 3.

FIG. 1 is a cross-sectional view showing a schematic structure of a klystron 10. As shown in FIG. 1, the klystron 10 comprises an electron gun unit A that emits electrons 11. The electron gun unit A comprises a cathode 12a that generates electrons 11, an anode 12b that accelerates electrons 11, and the like.

A high-frequency interaction unit B is provided in front of the electron gun unit A located in the traveling direction of the electrons 11. The high-frequency interaction unit B comprises a cylindrical tube container 13 and a plurality of resonant cavities 14 formed in the tube container 13 and arranged along the traveling direction of the electrons 11. The high-frequency interaction unit B comprises, for example, ten resonant cavities 14a to 14j.

A collector 15 that captures the electrons 11 having passed through the high-frequency interaction unit B (resonant cavities 14a to 14j) is provided in front of the high-frequency interaction unit B located in the traveling direction of the electrons 11.

Drift tubes 16a to 16k are connected between the electron gun unit A and the high-frequency interaction portion B, between the plurality of resonant cavities 14a to 14j, and between the high-frequency interaction portion B and the collector 15, respectively. The tube container 13 constituting the resonant cavities 14a to 14j and the drift tubes 16a to 16k is formed of, for example, copper.

In addition, an input unit 17 that inputs the high-frequency power is connected to the resonant cavity 14a located on the electron gun unit A side, of the plurality of resonant cavities 14a to 14j constituting the high-frequency interaction unit B, and an output unit 18 that outputs the high-frequency power is connected to the resonant cavity 14j located on the collector 15 side. For example, the input unit 17 is a coaxial line, and the output unit 18 is a waveguide.

Of the plurality of resonant cavities 14a to 14j constituting the high-frequency interaction unit B, the resonant cavity 14a located on the electron gun unit A side is an input cavity 19, and the resonant cavity 14j located on the collector 15 side is an output cavity 20, and a plurality of resonant cavities 14b to 14i located between the input cavity 19 and the output cavity 20 are intermediate cavities 21b to 21i.

Based on the above, the drift tube 16a is provided between the electron gun unit A and the input cavity 19. The drift tube 16k is provided between the output cavity 20 and the collector 15. Each of the drift tubes 16b to 16j is provided between a pair of adjacent resonant cavities of the plurality of resonant cavities 14a to 14j.

The intermediate cavities 21b to 21i include a plurality of fundamental wave cavities 22b, 22c, 22e, 22f, 22h, and 22i, and a plurality of second harmonic cavities 23d and 23g. The plurality of second harmonic cavities 23d and 23g are provided at arbitrary positions in the intermediate cavities 21b to 21i. A plurality of fundamental wave cavities 22b and 22c are interposed between the second harmonic cavity 23d on the side close to the electron gun unit A and the input cavity 19, the plurality of fundamental wave cavities 22h and 22i are interposed between and the second harmonic cavity 23g on the side close to the collector 15 and the output cavity 20, and the plurality of fundamental wave cavities 22e and 22f are interposed between the second harmonic cavities 23d and 23g.

In the present embodiment, the number of resonant cavities 14a to 14j is ten, the number of intermediate cavities 21b to 21i is eight, and the number of second harmonic cavities 23d and 23g is two. In this case, second harmonic cavities 23d and 23g are provided at every two positions of the intermediate cavities 21b to 21i with respect to the traveling direction of the electrons 11. Therefore, the intermediate cavities 21b, 21c, 21e, 21f, 21h, and 21i are the fundamental wave cavities 22b, 22c, 22e, 22f, 22h, and 22i, and the intermediate cavities 21d and 21g are the second harmonic cavities 23d and 23g.

FIG. 2 is a cross-sectional view showing a part of the tube container 13 of the klystron 10, showing the second harmonic cavities 23d, 23g, and the like. As shown in FIG. 2, the second harmonic cavities 23d and 23g are formed to be smaller in shape than the fundamental wave cavities 22b, 22c, 22e, 22f, 22h, and 22i that are the intermediate cavities 21b, 21c, 21e, 21f, 21h, and 21i other than the second harmonic cavities 23d and 23g. That is, the second harmonic cavities 23d and 23g have a smaller outer diameter OD, a narrower width in the traveling direction of electrons, and a smaller cavity volume than the fundamental wave cavities 22b, 22c, 22e, 22f, 22h, and 22i, and an opening width of the gap (opening) 24 communicating with the interior of the drift tubes 16a to 16k is also formed to be small.

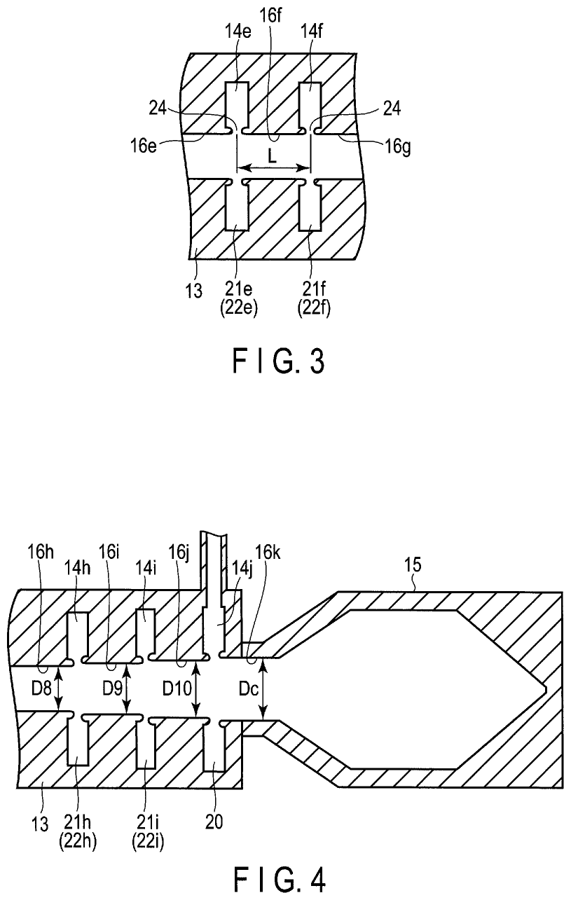

FIG. 3 is a cross-sectional view showing a part of the tube container 13 of the klystron 10, illustrating the interval between the resonant cavities 14a to 14j. FIG. 3 shows the relationship between the resonant cavities 14e and 14f representing the resonant cavities 14a to 14j, but the relationship between the other resonant cavities 14a to 14e and 14f to 14j is the same. As shown in FIG. 3, the resonant cavities 14e and 14f (14a to 14j) have a gap 24 communicating with the interior of the drift tubes 16e to 16g (16b to 16j). The distance L between the centers of the gaps 24 of the resonant cavities 14e and 14f (14a to 14j) adjacent via the drift tube 16f (16b to 16j) is the distance between the resonant cavities 14e and 14f (i.e., the distance between a pair of adjacent resonant cavities 14 of the resonant cavities 14a to 14j). When the density of the bunched electrons 11 propagates in the traveling direction, the distance L is desirably 0.05 to 0.08 times the reduced plasma wavelength representing the wavelength.

As shown in FIG. 1, in the klystron 10 configured as described above, the electrons 11 emitted from the electron gun unit A pass through the resonant cavity 14a (input cavity 19) on the electron gun unit A side having an input unit 17 for high-frequency power, and interacts with the plurality of resonant cavities 14b to 14j (the plurality of intermediate cavities 21b to 21i and the output cavity 20) in front of the resonant cavity 14a and are bunched. The bunched electrons 11 are decelerated in the resonant cavity 14j (output cavity 20) on the collector 15 side, and are extracted from the output unit 18 as the high-frequency power amplified to a target output.

When the electrons 11 are bunched by interaction with the plurality of resonant cavities 14b to 14j, the plurality of resonant cavities 14b to 14j (the plurality of intermediate cavities 21b to 21i) include the plurality of second harmonic cavities 23d and 23g and, the second harmonic generated in the second harmonic cavities 23d and 23g is therefore superimposed on the fundamental wave, and the effect of bunching the electrons 11 is enhanced.

For example, when electrons are bunched using five resonant cavities, the bunched electrons repel each other due to space charge and the electrons can easily spread in the traveling direction since the degree of gathering of the electrons in each resonant cavity is large, and the electrons cannot be uniformly decelerated with a resonant cavity (output cavity) connected to the output unit and the efficiency of conversion into high-frequency power can hardly be improved since the speed of electrons is varied.

In contrast, in the present embodiment, the electrons 11 can be gradually bunched by, for example, ten resonant cavities 14a to 14j. Thus, the spread of the bunched electrons 11 in the traveling direction is suppressed, the speed is made uniform, and the efficiency of conversion into the high-frequency power can be improved. The total number of the resonant cavities 14a to 14j is desirably ten or more in order to gradually bunch the electrons 11.

Furthermore, for example, the intermediate cavities 21b to 21i can include a plurality of second harmonic cavities 23d and 23g by using, for example, ten resonant cavities 14a to 14j, and the effect of bunching the electrons 11 can be further enhanced. In addition, the total length of the klystron 10 can be shortened by using the plurality of second harmonic cavities 23d and 23g.

The plurality of intermediate cavities 21b to 21i are arranged along the traveling direction of the electrons 11. Two or more intermediate cavities 21 are interposed between the second harmonic cavity 23 on the upstream side and the second harmonic cavity 23 on the downstream side, in the traveling direction of the electrons 11. Of the plurality of intermediate cavities 21b to 21i, the plurality of intermediate cavities 21 (fundamental wave cavities 22) other than the plurality of second harmonic cavities 23 include the two or more intermediate cavities 21.

In the present embodiment, the plurality of second harmonic cavities 23d and 23g are provided at positions where the plurality of intermediate cavities 21e and 21f are provided between the second harmonic cavity 23d on the upstream side and the second harmonic cavity 23g on the downstream side, in the traveling direction of the electron 11, of the positions of the plurality of intermediate cavities 21b to 21i. The effect of bunching the electrons 11 can be further enhanced.

By providing the second harmonic cavities 23d and 23g at every plural positions of the intermediate cavities 21b to 21i with respect to the traveling direction of the electrons 11, the plurality of second harmonic cavities 23d and 23g can be arranged at equal intervals in the plurality of intermediate cavities 21b to 21i, and the effect of bunching the electrons 11 can be further enhanced.

As shown in FIG. 1 and FIG. 2, to prevent the second harmonic generated in the second harmonic cavities 23d and 23g from being electrically coupled to the other resonant cavities 14a to 14c, 14e, 14f, and 14h to 14j, the diameter (inner diameter) D of the drift tubes 16d, 16e, 16g, and 16h adjacent to the second harmonic cavities 23d and 23g is desirably set to half or less of diameter (inner diameter) at which the electromagnetic wave of TE11 mode of the second harmonic is a cutoff frequency.

As shown in FIG. 1 and FIG. 3, when the density of the bunched electrons 11 propagates in the traveling direction, the distance L between the centers of the gaps 24 of the resonant cavities 14a to 14j adjacent via the drift tubes 16b to 16j is set to 0.05 to 0.08 times the reduced plasma wavelength representing the wavelength thereof and the arrangement of the resonant cavities 14a to 14j can be thereby optimized.

It is arbitrarily determined which of the resonant cavities 14a to 14j is used as the second harmonic cavity 23, and three or more second harmonic cavities 23 may be used. When the plurality of intermediate cavities 21 include three or more second harmonic cavities 23, two or more intermediate cavities 21 (fundamental wave cavities 22) are desirably interposed between a pair of adjacent second harmonic cavities 23.

Next, a klystron 10 of the second embodiment will be described with reference to FIG. 4. The same constituent elements as those of the first embodiment will be denoted by the same referential numerals, and descriptions of the constituent elements and the advantages will be omitted.

FIG. 4 is a cross-sectional view showing a tube container 13 and a collector 15 of the klystron 10 of the second embodiment, illustrating diameters of drift tubes 16h to 16k.

As shown in FIG. 4, the total number of the resonant cavities 14a to 14j is referred to as n, and the diameter Dn of the drift tube 16j located between the n-th resonant cavity 14j and the (n−1)-th resonant cavity 14i as counted from the side close to the electron gun unit A, the diameter Dn−1 of the drift tube 16i located between the (n−1)-th resonant cavity 14i and the (n−2)-th resonant cavity 14h, the diameter Dn−2 of the drift tube 16h located between the (n−2)-th resonant cavity 14h and the (n−3)-th resonant cavity 14g, and the diameter Dc of the drift tube 16k located between the n-th resonant cavity 14j and the collector 15 satisfy the following formula (1).

Dn−2<Dn−1<Dn<Dc formula (1)

For example, when the diameters of the drift tubes 16h to 16k are referred to as D8, D9, D10, and Dc, respectively, from the formula (1), they have a relationship D8<D9<D10<Dc.

The bunched electrons 11 can be gradually expanded in the diameter direction of the drift tubes 16h to 16k and the electrons 11 can be prevented from spreading in the traveling direction by repelling caused by the space charge, by using the drift tubes 16h to 16k that satisfy formula (1), and the efficiency of conversion into high-frequency power can be thereby easily improved.

Gradually increasing the diameter of the drift tube 16 toward the side closer to the collector 15 is not limited to the drift tubes 16h to 16k located on the side closer to the collector 15, but any number of drift tubes of the drift tubes 16a to 16k may be gradually widened toward the collector 15.

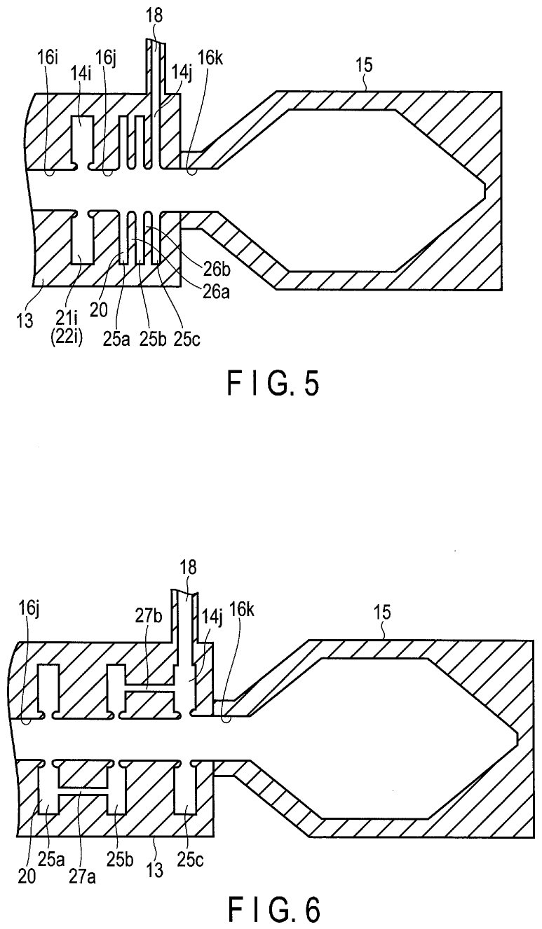

Next, a klystron 10 of a third embodiment will be described with reference to FIG. 5. The same constituent elements as those of each embodiment will be denoted by the same referential numerals, and descriptions of the constituent elements and the advantages will be omitted.

FIG. 5 is a cross-sectional view showing a tube container 13 and a collector 15 of a klystron 10 of the third embodiment, and shows cavity cells 25a to 25c and the like.

As shown in FIG. 5, the resonant cavity 14j that is the output cavity 20 has three or more cavity cells 25. In the present embodiment, the output cavity 20 has three cavity cells 25a to 25c. The respective cavity cells 25a to 25c are electrically coupled by irises 26a and 26b provided along the tube axis of the klystron 10.

Then, since the electrical coupling between the resonant cavity 14j and the electrons 11 can be enhanced by using the cavity cells 25a to 25c that are electrically coupled to each other as the resonant cavity 14j, the efficiency of conversion into high-frequency power can easily be improved.

Next, a klystron 10 of a fourth embodiment will be described with reference to FIG. 6. The same constituent elements as those of each of the embodiments will be denoted by the same referential numerals, and descriptions of the constituent elements and the advantages will be omitted.

FIG. 6 is a cross-sectional view showing a tube container 13 and a collector 15 of the klystron 10 of the fourth embodiment, and shows cavity cells 25a to 25c and the like.

As shown in FIG. 6, the cavity cells 25a to 25c are electrically coupled by coupling holes 27a and 27b provided on the wall surfaces of the cavity cells 25a to 25c. The shapes of the coupling holes 27a and 27b are arbitrarily determined.

The cavity cells 25a to 25c electrically coupled to each other can be used as the resonant cavity 14j (output cavity 20). In this case, too, since the electrical coupling between the resonant cavity 14j and the electrons 11 can be enhanced, the efficiency of conversion into high-frequency power can easily be improved.

According to at least one embodiment described above, the klystron 10 wherein spread of the bunched electrons 11 in the traveling direction is suppressed by the resonant cavities 14a to 14j, the speed is made uniform, and the efficiency of conversion into high-frequency power is thereby improved, can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A klystron comprising:
an electron gun unit that emits electrons;
a plurality of resonant cavities including an input cavity, a plurality of intermediate cavities, and an output cavity that are sequentially located along a traveling direction of electrons from the electron gun unit, the plurality of intermediate cavities including a plurality of second harmonic cavities;
a collector that captures electrons passing through the plurality of resonant cavities; and
a plurality of drift tubes provided between the electron gun unit and the input cavity, between the plurality of resonant cavities, and between the output cavity and the collector.

2. The klystron of claim 1, wherein
a total number of the plurality of resonant cavities is ten or more.

3. The klystron of claim 1, wherein
the plurality of intermediate cavities are arranged along the traveling direction of electrons,
two or more intermediate cavities are interposed between a second harmonic cavity on an upstream side and a second harmonic cavity on a downstream side, in the traveling direction of electrons, and
a plurality of intermediate cavities other than the plurality of second harmonic cavities, of the plurality of intermediate cavities, include the two or more intermediate cavities.

4. The klystron of claim 1, wherein
a diameter of a drift tube adjacent to the second harmonic cavity is equal to or less than a half of a diameter at which an electromagnetic wave in TE11 mode of a second harmonic becomes a cutoff frequency.

5. The klystron of claim 1, wherein
each of the plurality of resonant cavities has a gap communicating with an interior of the drift tube, and
a distance between centers of the gaps of a pair of adjacent resonant cavities, of the plurality of resonant cavities, is 0.05 to 0.08 times a reduced plasma wavelength of electrons.

6. The klystron of claim 1, wherein
when a total number of the plurality of resonant cavities is referred to as n, when a diameter of the drift tube located between the n-th resonant cavity and the (n−1)-th resonant cavity as counted from a side closer to the electron gun unit is referred to as Dn, when a diameter of the drift tube located between the (n−1)-th resonant cavity and the (n−2)-th resonant cavity is referred to as Dn−1, when a diameter of the drift tube located between the (n−2)-th resonant cavity and the (n−3)-th resonant cavity is referred to as Dn−2, and when a diameter of the drift tube located between the n-th resonant cavity and the collector is referred to as Dc, Dn−2<Dn−1<Dn<Dc.

7. The klystron of claim 1, wherein
the output cavity is composed of three or more cavity cells, and
the cavity cells are electrically coupled to each other by an iris provided in a longitudinal direction of the drift tube or a coupling hole provided on a wall surface of the cavity cell.

8. The klystron of claim 7, wherein
a total number of the cavity cells is three.
